(19) United States
(12) Patent Application Publication
(10) Pub. No.: US 2012/0056702 A1
(43) Pub. Date: Mar. 8, 2012

(54) VOLTAGE/CURRENT TRANSFORMER AND ITS MANUFACTURING PROCEDURE

(75) Inventor: Jose SEBASTIAN BALSALOBRE, Montornes del Valles (ES)

(73) Assignee: RS ISOLSEC, S.L., Barcelona (ES)

(21) Appl. No.: 13/221,479

(22) Filed: Aug. 30, 2011

(30) Foreign Application Priority Data
Sep. 3, 2010 (EP) 10380114.8

(51) Int. Cl. H01F 27/02; H01F 7/06

(52) U.S. Cl. 336/96; 29/602.1

(57) ABSTRACT

A measurement and protection transformer for high, medium and low voltages, of the type having a magnetic core, together with primary and secondary windings. All these elements are exteriorly molded with resin, forming a single, exterior resin body to obtain a transformer design with all the guarantees of safety and durability, especially under extremely humid environmental conditions. The transformer is for high, medium and low voltages that has a magnetic core, together with primary and secondary windings and transformer primary and secondary connections, with the particularity in which all these elements are molded and completely embedded within a mass of resin that forms the outer body or single-piece casing of the transformer.

This application claims benefit of Serial No. 10380114.8, filed 3 Sep. 2010 in the European Patent Office and which application is incorporated herein by reference. To the extent appropriate, a claim of priority is made to each of the above disclosed applications.

### BACKGROUND OF THE INVENTION

The present invention refers to a measurement and protective high, medium and low voltage transformer of the type comprising a magnetic core with primary and secondary windings, all of which are molded on the outside with resin, with the formation of a single-piece outer enclosure made of resin, the main objective of the present invention consisting in obtaining a transformer design with all safety guarantees and durability in particular in ambient conditions of high or extremely high humidity.

### FIELD OF THE INVENTION

High, medium or low voltage transformers of this type are devices that are usually installed at various points of high or medium voltage lines of an electrical distribution network.

### PRIOR ART

Measurement transformers are mainly used for installing instruments, counters y protective relays in medium or high voltage circuits, and their task is to insulate measurement or relay circuits, thus allowing greater standardization in the construction of counters, instruments or relays.

The process for manufacturing conventional high, medium or low voltage transformers consists in manufacturing the core and windings and molding the outer enclosure of the transformer with resin. The primary and secondary connections go out from the core. These primary and secondary connections are precisely the ones that are particularly susceptible to becoming easily damaged by external influences, thus impairing the entire functioning of the transformer.

Accordingly, one of the main drawbacks of this type of transformers is their high susceptibility in humid conditions and environments or in immersed environments, due to the fact that they are not sufficiently prepared for withstanding such extreme circumstances, which means that transformers of this type can become totally or partially damaged when continuously or sporadically exposed to such humid environments.

Taking into account that these transformers are installed in various types of terrain, usually inside larger rooms for protection (usually referred to as “stations”), it is easy to understand that climatic conditions such as rain, flooding or humidity can cause flooding in these stations, thus inevitably affecting the correct functioning of the transformer(s) housed on the inside and causing the electrical protective devices of the entire electrical zone or area to become interrupted until repair of the breakdown can be achieved and the electrical service resumed.

The solution to solving this problem has previously consisted in insulating the entire outer area of the station, preferentially made of concrete, in which the voltage transformers are installed, from water and humidity by applying and sealing a water-insulating material or element. However, such a solution involves very high costs necessary for sealing the entire outer surroundings of the transformer station.

For all these reasons, the objective of the present invention is to overcome the disadvantages associated with the prior art and provide a new method of constructing low, medium and high voltage transformers capable of withstanding ambient conditions of very high humidity with potential flooding, and withstanding immersion in water without failing or breaking down.

### SUMMARY OF THE INVENTION

The present invention proposes a high, medium or low voltage transformer comprising a magnetic core with primary and secondary windings and primary and secondary connections of the transformer, with the special feature that all these elements are molded while they are completely embedded in a mass of resin, thus forming the entire outer single-piece enclosure or housing of the transformer, so that at least the inner part of the terminals of the corresponding primary and secondary connections of the transformer remain completely embedded in said mass of resin, so that the contact surface of the primary connection and the secondary connection(s) with the housing are completely insulated from water, said transformer being suitable for immersion in water and also for withstanding conditions in humid environments at extremely high hydrophilic levels.

The primary connection of the transformer is arranged in the upper part of the transformer, whereas the secondary connections of the transformer are located in the lower part. Said connections can be connectors (that is, metal terminals) or simply cables, depending on the type of transformer. The secondary connection(s) mentioned preferably go in pairs, i.e., they can be 2, 4, 6, etc., although there can also be only one.

As mentioned above, if the primary and secondary connections are conductors (that is, metal terminals), at least an inner portion of the terminals of the corresponding primary and secondary connections of the transformer are completely embedded and trapped in said mass of resin; however, according to a second embodiment of the invention, said primary and secondary connections can be simple cables, so that a portion of said cables is completely embedded and trapped in said mass of resin, so that the contact surface of the corresponding cables together with the single-piece housing are completely insulated from water.

Said resin layer which forms the outer housing of the transformer is manufactured by resin molding technology. If the connections are made via connectors, said connectors are placed at the appropriate position inside the mold insert before the molding operation of the resin, so that the resin is poured onto said connector, and the latter remains partially embedded inside the mass of resin with its front part. Precisely said front part is the one that is used for connection to an external connector.

The type of resin used for molding the outer housing to a single-piece is preferably an epoxy type resin, which has excellent properties as electrical insulator, although alternatively other resins with equivalent properties can also be used.

The wall thickness of the mass of resin up to the winding is a function of the required insulating voltage en each type of transformer and can range, for example, from a few millimetres to a few centimetres.

Optionally, this resin housing can be coated on the outside with a metallized layer, suitable for preventing adverse effects from external influences that act on the transformer during its lifetime and also act as mass and thus serve as electric insulator.

According to a second embodiment of the invention, said resin housing can be coated on the outside with a silicone layer or a similar material, in order to provide a higher degree of insulation against water.

According to a third embodiment of the invention, said resin housing can be coated on the outside with a metallized layer, and said layer can be coated on the outside with a second silicone layer, in order to provide double insulation or protection against external influences and against water.

Both layers (metallized layer and silicone layer) are applied by spraying methods or other equivalent painting methods.

An earth connection will also be available and arranged close to the secondary connection.

Optionally, the magnetic core with the primary and secondary windings can initially be placed inside a plastic housing arranged around the entire core of the transformer or part of it, which serves as support for certain auxiliary elements. This is followed by molding them inside the resin mold insert, which, upon setting, forms the outer resin housing to a single piece.

Advantageously, it has been found in an empirical trial that this transformer can be immersed in water down to a depth of 20 metres without suffering damage and can also withstand the conditions of humid environments at extremely high hydrophilic levels.

It goes without saying that the outer configuration of the transformer enclosure can vary according to the transformer specifications in each case, preference being given to a substantially outer prismatic configuration.

The process of constructing the transformer disclosed by the present invention mainly comprises the steps of:
connecting the cables of the different auxiliary elements, such as the primary connector and the secondary connector, to the winding and then mounting the entire set in the core,
placing this assembled set inside a mold, closing the mold and pouring the mass of resin inside,
optionally coating the resin housing on the outside with a metallized or silicone layer, and
also optionally, coating said metallized layer on the outside with another silicone layer.

Preferably, the molding operation of the mass of resin is carried out under vacuum.

### BRIEF DESCRIPTION OF THE DRAWING FIGURES

FIG. 1 is a perspective front view of the outer part of the transformer disclosed by the present invention.

FIG. 2 is a sectional front view of the transformer shown in FIG. 1.

FIG. 3 is a sectional side view of the transformer shown in FIG. 1.

FIG. 4 is a sectional front view of the transformer, which is the second preferred embodiment of the present invention.

The main elements will now be described in detail, all of which will be accompanied by a number in the attached figures; (10) transformer, (11) mass of resin, (12) outer metallic or silicone coating, (13) magnetic core, (14) windings, (15) cover of the primary connector (16), (16) primary connector, (16′) primary cable, (18) secondary connectors, (18′) secondary cables, (19) mounting base, (20) openings for the anchoring means, (21) cable of the primary circuit, (22) cable of the secondary circuit.

### DESCRIPTION OF ONE OF THE EMBODIMENTS OF THE INVENTION

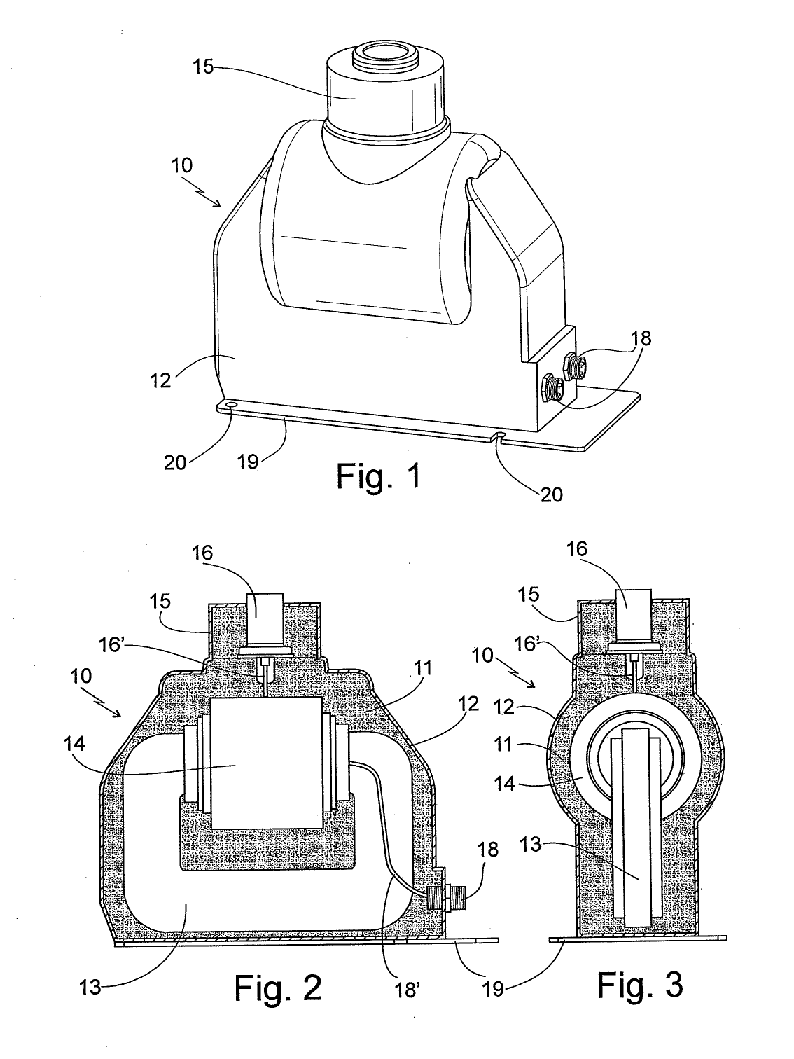

In one of the preferred embodiments of the invention, as can be seen from FIG. 1, the transformer (10) shown refers to a single-phase single-pole insulated medium voltage measurement transformer for 50-60 Hz, which comprises a magnetic core (13) with primary and secondary windings (14) and a primary (16) and two secondary (18) connections, which are all accommodated in an outer housing made of a mass of resin (11), which is molded around said components (13, 14, 16, 18) inside a mold (not shown in the figures), so that part of the metal terminals of the primary (16) and secondary (18) connections of the transformer (10) are embedded inside said mass of resin (11).

In the special case of the embodiments of FIGS. 1-3, the primary connection of the transformer (10) consisting of a connector (16) is arranged in the central upper part of the transformer (10) and is partially covered by the mass of resin (11) which encapsulates an upper portion of substantially cylindrical configuration from which part of the primary terminal protrudes. The outer configuration of the primary connection (16) can also have other forms: for example truncated-conical or others.

In the special case of the embodiment of FIGS. 1-3, the secondary connections of the transformer (10) consisting of a pair of connections (18) are located in the lower part of one of the side walls of the transformer (10). Said secondary connections can also be arranged in other parts of the lower area of the transformer. As with the primary connector (16), the two innermost parts of the metal terminals (18a) of the two secondary connectors (18) are embedded inside the mass of resin (11).

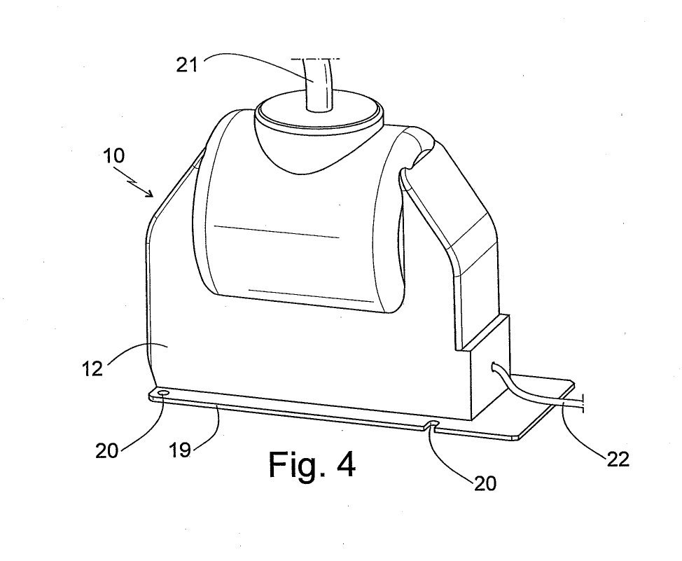

In the special case of the second embodiment corresponding to FIG. 4, the primary connection (16) of the transformer (10) consists of a simple cable (16′) which is arranged at the exit of the central upper part of the transformer (10) and is partially covered by the mass of resin (11), which encapsulates an upper portion of substantially cylindrical configuration, so that the outer part of the cable (16′) protrudes, in order to become connected. As for the secondary connections of the transformer (10), they each consist of cables (18′), which are completely embedded in the mass of resin (11) which shapes the housing, so that there is no opening left through which the water can drain towards the interior of the transformer (10).

After having sufficiently described the present invention with reference to the attached figures, it goes without saying that any modifications which are deemed convenient can be made to the invention, as long as the essential aspects of the present invention, which is summarized in the following claims, are not changed.

1. A voltage/current transformer, comprising: a magnetic core with primary and secondary windings and primary and secondary connections, wherein assembly of the magnetic core with the primary and secondary windings and the primary and secondary connections are molded and completely embedded in a mass of resin, which forms an entire outer enclosure or single-piece housing of the transformer, so that at least an inner portion of terminals of the corresponding primary and secondary connections of the transformer becomes completely embedded in said mass of resin, so that a contact surface of the primary connection and the secondary connections with the housing are completely insulated from water, said transformer being suitable for immersion in water without becoming damaged down to a depth of 20 meters and also for withstanding conditions in humid environments at high hydrophilic levels.

2. A voltage/current transformer according to claim 1, wherein the resin used to mold the outer housing is epoxy type resin.

3. A voltage/current transformer according to claim 1, wherein the resin housing can be coated on the outside with a metallized layer suitable for preventing damaging effects by external influences that act on the transformer during a lifetime of the transformer and act as mass and thus serve as electrical insulator.

4. A voltage/current transformer according to claim 3, wherein the metallized layer can be coated on the outside with another layer of silicone to provide additional insulation against water.

5. A voltage/current transformer according to claim 1, wherein the resin housing is coated on the outside with a layer of silicone or a different material to provide additional insulation against water.

6. A process for manufacturing the voltage/current transformer according to claim 1, the method comprising the steps of:
connecting cables of different auxiliary elements including the primary connection and the secondary connection, to the windings to form an assembly and then mounting the assembly in the core,
placing the assembly inside a mold, closing the mold and pouring the mass of resin inside the mold,
coating the resin housing on the outside with a metallized or silicone layer, and
coating said metallized layer on the outside with another silicone layer.
